(19) United States
(12) Patent Application Publication
(10) Pub. No.: US 2016/0045969 A1
(43) Pub. Date: Feb. 18, 2016

(54) METHOD FOR PRODUCING A COMPONENT OF A VACUUM INTERRUPTER

(71) Applicant: SIEMENS AKTIENGESELLSCHAFT, München (DE)

(72) Inventors: Frank GRASKOWSKI, Wandlitz (DE); Andreas LAWALL, Berlin (DE); Oliver STIER, Berlin (DE)

(73) Assignee: SIEMENS AKTIENGESELLSCHAFT, Munich (DE)

(21) Appl. No.: 14/778,692

(22) PCT Filed: Mar. 5, 2014
(86) PCT No.: PCT/EP2014/054226

§ 371 Date: Sep. 21, 2015

(30) Foreign Application Priority Data
Mar. 19, 2013 (DE) 10 2013 204 775.4

(51) Int. Cl. B23K 1/00; B23K 35/30; C23C 4/00; C23C 4/02; C23C 4/12; C23C 4/08

(52) U.S. Cl. CPC B23K 1/00; C23C 4/12; C23C 4/08; C23C 4/005; C23C 4/02; B23K 35/3006; B23K 2203/08

(57) ABSTRACT

A method produces a component of a vacuum interrupter, such as a cover or a shielding part. These components are produced having a layer of a solder material. According to the method, the coating with the solder material is carried out by thermal spraying, in particular cold gas spraying. The components can be partially coated and only in a partial region. After developing the solder connection, the material flows out of the connection regions into the developing solder connection. Coating by thermal spraying allows larger components, such as housing components, to be partially coated and, in comparison. If electro-thermally silver-coating avoided, a more cost-effective production of the vacuum interrupter is possible.

### CROSS REFERENCE TO RELATED APPLICATIONS

This application is based on and hereby claims priority to International Application No. PCT/EP2014/054226 filed on Mar. 5, 2014 and German Application No. 10 2013 204 775.4 filed on Mar. 19, 2013, the contents of which are hereby incorporated by reference.

### BACKGROUND

The invention relates to a method for producing a component of a vacuum interrupter in which the component after its manufacture is coated with a coating of a solder material.

Connecting components of vacuum interrupters by solder materials is known from DE 101 51 105 C1, for example. Here, the problem has to be solved that the solder material for the soldered connection to be produced has been able to be made available as uniformly as possible. Here, soldering films or soldering rings are used, or copper parts are, for example, completely silver-plated, respectively, wherein silver is employed as the solder material. In a subsequent brazing process, silver-based solders are suitable for producing the soldered connections between the components of the vacuum interrupters.

The copper parts, for example the soldering rings, are currently completely silver-plated for reasons of process technology. This is performed, for example, by electrochemical deposition of the silver on the respective copper part. On account thereof, it cannot, however, be excluded that solder material which subsequently does not contribute toward forming the soldered connection is also deposited on the rings.

### SUMMARY

It is thus one possible object to state a method for producing a component for the vacuum interrupter in which production of the coating of the solder material is possible at optimum material investment.

The inventors propose a method in which coating is performed by thermal spraying of a powder from the solder material containing silver. This coating is intended to enable this component to be soldered to other components of the vacuum interrupter. A possible objective here is to establish a hermetically sealed component connection, so that the vacuum in the interior of the vacuum interrupter may be maintained. The advantage of the application of thermal spraying here lies in that components may also be partially coated in that the coating jet is directed in a targeted manner onto those portions of the component that adjoin the soldered connection to be configured. The component therefore preferably is a housing part. Thereby also comparatively large housing parts may be advantageously coated with the solder material, such that auxiliary components, such as soldering rings having a comparatively small volume may be saved. On account thereof, construction of the housing is advantageously simplified, such that not only the employment of the solder material may be optimized in terms of material consumption, but that also the complexity of individual components and the complexity in assembly of the vacuum interrupter may be reduced. Overall, the measure of using a thermal spraying method for the coating with solder material thus offers the potential for manufacturing more cost-effective vacuum interrupters.

According to one advantageous design embodiment it is provided that the thermal spraying used is cold-gas spraying. The latter is advantageously particularly well suited to processing particles containing silver, which may be advantageously deposited on the components at a powder loss in the range of 1 to 2%.

Cold-gas spraying is a method which is known per se in which particles which are provided for the coating are accelerated preferably to supersonic speed by a convergent/divergent nozzle so that said particles, on account of their impressed kinetic energy, adhere to the surface to be coated. Here, the kinetic energy of the particles is used, leading to plastic deformation of said particles, wherein the coating particles upon impact are only fused on the surface thereof. As opposed to other thermal spraying methods, this method is therefore referred to as cold-gas spraying, because it is performed at comparatively low temperatures in which the coating particles remain substantially solid. A cold-gas spraying system which has a gas heating installation for heating a gas is preferably used for cold-gas spraying, the latter also being referred to as kinetic spraying. A stagnation chamber which on the outlet side is connected to the convergent/divergent nozzle, preferably a Laval nozzle, is connected to the gas heating installation. Convergent/divergent nozzles have a converging part-portion and a diverging part-portion, both being connected by a nozzle throat. The convergent/divergent nozzle on the outlet side generates a power jet in the form of a gas stream having therein high-speed particles, preferably supersonic-speed particles.

According to another design embodiment, it is provided that the component is only coated in a surface region which after production of the soldered connection is not more than 10% larger than the connection region to be produced between the component and the soldered connection. Here, tolerances which may arise during application of the spraying method may be advantageously compensated for. The somewhat larger area on the component leads to be components to be joined completely bearing on the solder material, despite any potential deviations on account of tolerances. During the solder operation the solder material, on account of its flowability, is anyway drawn from the 10% larger surface region into the connection region to be produced.

The surface region in the context of the application is thus understood to be that region which is provided on the respective component for applying the solder material. The connection region is understood to be that region on the surface of the components to be connected, in which the components lie mutually adjacent so closely that the gap formed thereby may be filled by the solder material. It goes without saying here that the amount of solder material made available in terms of volume is sufficient for configuring the soldered connection in the entire connection region of the respective component.

According to one particular design embodiment, it is provided that the component is only coated in a surface region which after production of the soldered connection forms a connection region which contacts the soldered connection. In this case, the solder material is advantageously conceived to precisely fit the connection region to be configured. In the case of the only partial coating one may advantageously benefit therefrom that by way of the thermal spraying method, in particular the cold-spraying method, also comparatively large coating thicknesses may be applied onto the connection region, such that the material in this surface region in terms of the configured volume thereof is adequate for the soldered connection to be reliably configured.

It may furthermore be advantageously provided that alternating layers of silver and copper are produced on the component by way of thermal spraying. On account thereof, it is advantageously made possible that components which have not been manufactured from copper are also connected by soldering. It is not required that the copper is diffused into the soldered connection from the adjacent components, but the change in the layers between copper and silver in the applied solder material ensures that the soldered connection is configured from an optimal composition of the alloy. The composition of the alloy may be adjusted by way of the selected coating thicknesses of the individual layers. Like silver, copper may be readily deposited by cold-gas spraying.

Alternatively, it is also possible for a powder mixture containing silver and copper to be used in thermal spraying. It is in particular understood here that both silver particles as well as copper particles are provided in the powder. Said particles may likewise be mutually mixed in a ratio which is optimized with a view to the desired composition of the alloy. By reducing the proportion of copper powder, it may also be considered here that the adjacent components are manufactured from copper, such that copper may diffuse from the adjacent copper parts of the soldered connection into the soldered connection. Here, both sufficient concentration of copper in the interior of the soldered connection as well as a reliable connection of the soldered connection to the adjacent copper parts is ensured.

If and when the thermal spraying used is cold-gas spraying, it may be furthermore advantageously provided that the coating parameters are adjusted in such a manner that adherence of the powder to the surface to be coated is precluded, but that the latter is cleaned by the impacting particles of the powder. These coating parameters are of course maintained only until the surface has been cleaned of residues such as oxide coatings or grease. Subsequently, the parameters are modified such that the particles adhere to the freshly cleaned surface. The latter thus advantageously forms an ideal basis for reliable adhesion of the soldered connection to be able to be achieved on the substrate. The economy of the method is also advantageously improved thereby, since a dedicated cleaning process may be dispensed with. The reliability of the method may also be increased thereby, since coating with the solder particles is performed directly after cleaning, such that renewed contamination (for example oxidation) of the surface may be excluded.

The component by way of its major part may advantageously form a wall part of the housing or an electrical screening part. As has already been indicated, this is to mean that the component onto which the solder material is applied may also be larger on account of the potential for partial coating. No auxiliary part which in terms of volume is configured so as to be so minor that complete coating with silver is still economical must thus be provided. As already mentioned, the auxiliary components in the construction of the vacuum interrupter may be saved or at least reduced in numbers, on account of which construction may be designed so as to be simpler and assembly more efficient.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows an exemplary embodiment of a vacuum interrupter manufactured by way of an exemplary embodiment of the proposed method, in a longitudinal sectional view;

FIGS. 2 and 3 show exemplary embodiments of the proposed method, in which cold-gas spraying is employed;

FIG. 4 shows the detail IV from FIG. 1;

FIG. 5 shows the component according to FIG. 4, coated with solder, in a sectional view prior to soldering;

FIG. 6 shows the detail VI from FIG. 1;

FIG. 7 shows the components according to VI, coated with solder, in a sectional view prior to soldering; and

FIGS. 8 and 9 show various exemplary embodiments of coatings from the solder material in a sectional view.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

A vacuum interrupter 10 has a housing 11 which is substantially composed of two hollow cylindrical ceramic insulators 12 and 13, which are disposed so as to be mutually concentric, and two covers 14 and 15. Current-carrying bolts 16, 17 to a contact assembly which is not illustrated in more detail are routed through the covers 14, 15. A bellows 18, which on the one side is soldered to the cover 15 and on the other side is soldered to the current-carrying bolt 16, also forms part of the housing.

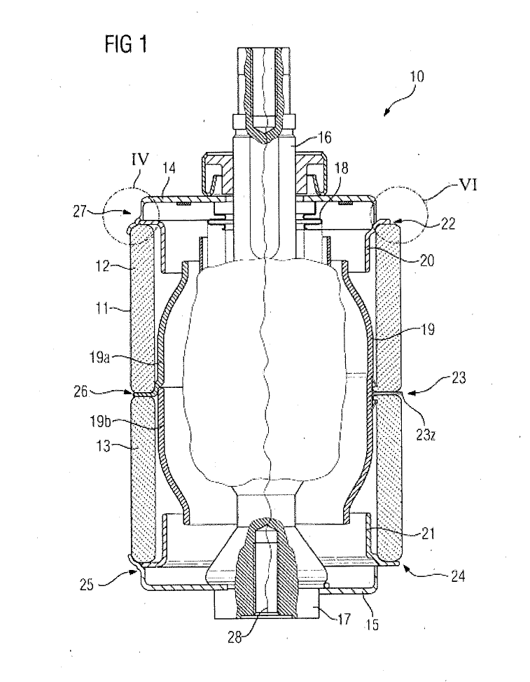

A primary shield 19 and, as shielding elements, an upper end shield 20 and a lower end shield 21 are disposed within the housing. The housing 11 furthermore has connection regions 22, 23, 24, in which the covers 14 and 15 are connected to the ceramic insulators 12 and 13 and the two ceramic insulators 12 and 13 are interconnected. In order for these connection regions to be produced, the soldered connections described in more detail below which are not illustrated in more detail in FIG. 1 will be used. The mentioned connection regions represent different variants of the proposal and are all illustrated by the vacuum interrupter 10 according to FIG. 1. Therefore, there is a break line 28 in FIG. 1 in order to indicate that the structure which per se is centrically symmetrical to the right and left of the break line is specified with different variants of the method.

It is furthermore evident from FIG. 1 that an auxiliary component 23z of copper may be employed between the ceramic insulators 12 and 13. Said auxiliary part is only partially coated with silver, specifically (in a way not illustrated) in the border areas adjacent to the ceramic insulators 12, 13. This auxiliary component 23z enables the main shield 19, which is implemented so as to be unipartite, to be retained in the interior of the housing. Alternatively, the connection between the ceramic insulators 12, 13 may also be configured as is illustrated on the opposite side of FIG. 1, wherein the main shield 19 is assembled from two parts 19a, 19b. On account thereof, a flange which is suitable for configuring a soldered connection to two ceramic insulators 12, 13, may be configured. The two parts 19a, 19b of the main screen may also be mutually soldered.

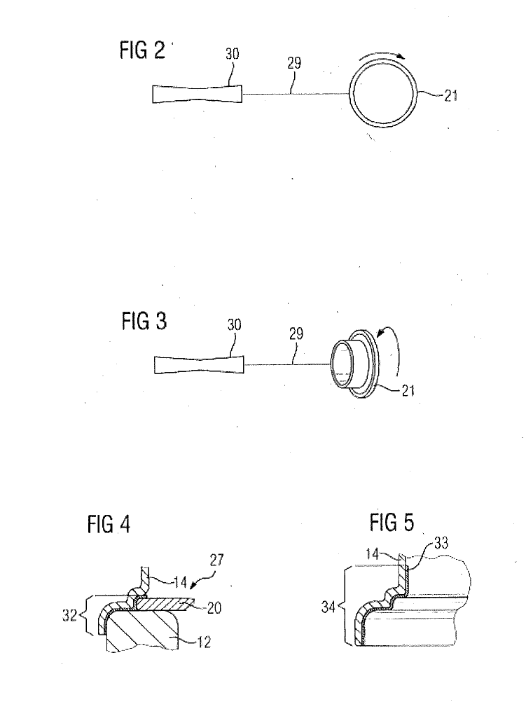

In order for the soldered connections according to FIG. 1 to be produced, at least part of the components has been coated with silver or silver and copper by cold-gas spraying prior to joining according to FIGS. 2 and 3. Here, as is illustrated in FIGS. 2 and 3, on account of the simple and centrically symmetrical geometry of the components to be coated, the latter may be rotated, so as to generate relative movement between a cold-gas jet 29 and the component (cf. the indicated arrows). According to FIGS. 2 and 3, the component may be the end shield 21, for example. In the case of the latter, the outer side and the rear side of the flange have to be coated. This may be achieved by way of different relative movements, as may be derived from FIGS. 2 and 3. Here, a cold-spray nozzle 30 of a cold-spraying system, which is not illustrated in more detail, is correspondingly oriented in an axial or radial manner in front of the component to be coated while the component is being rotated.

The connection 27 is illustrated in more detail in FIG. 4. In evidence are the cover 14, the ceramic insulator 12, and the end shield 20, all of which are hermetically closed off in relation to the environment by way of a soldered connection 31. The soldered connection is located in a connection region 32, this being that region in which the solder material expands on the cover 14 once the soldered connection 31 has been configured.

Comparing FIG. 4 with FIG. 5, it is evident that the cover 14 prior to the soldering operation has been coated with a coating 33 of the solder material. The latter has been applied onto a surface region 34 which is sized to be larger than the connection region 32 according to FIG. 4. However, while the soldered connection 31 is configured, the solder material runs into the gap formed by the components, on account of which that area of the cover 14 that is wetted by the solder material is reduced.

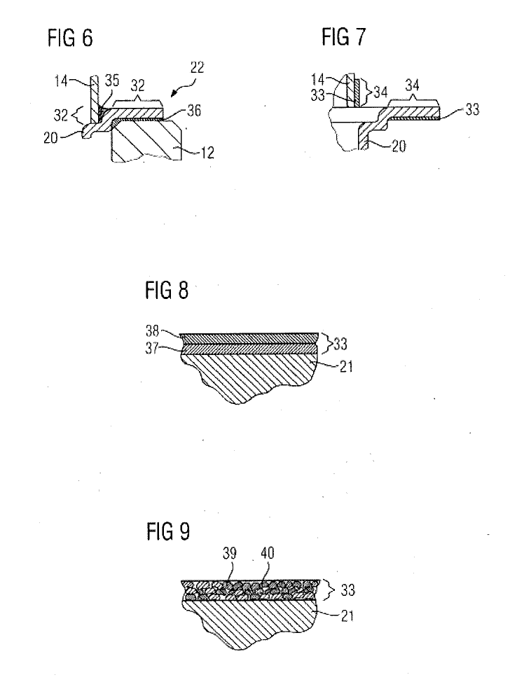

The connection region 22 is illustrated in more detail in FIG. 6. The latter has two soldered connections 35, 36, so as to interconnect the respective components according to FIG. 1 (ceramic insulator 12, cover 14, and end shield 20).

As may be derived from FIG. 7, the surface region 34 for the soldered connection 35 is again configured so as to be larger than the connection region 32 after configuration of the soldered connection 35. However, for the soldered connection 36 the connection region 32 in terms of area is of exactly the same size as the surface region 34 which prior to the configuration of the soldered connection is coated with the solder material.

The end shield 21 is illustrated in FIG. 8 as the detail which has been coated according to FIGS. 2 and 3. According to FIG. 8, the coating 33 is composed of a layer 37 of copper and a layer 38 of silver. Further layers of silver and copper (not illustrated) may be added to these layers, such that the solder material is composed of a layered sandwich.

According to FIG. 9, the coating 33 on the end shield 21 may also alternatively be configured from particles of various compositions. Said particles in FIG. 9 are indicated by opposite hatchings for the particles 39 of copper and the particles 40 of silver.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-8. (canceled)

9. A method for producing a component of a vacuum interrupter, comprising:
after the component is manufactured, coating the component with a solder material, the coating being performed by thermal spraying a powder containing silver.

10. The method as claimed in claim 9, wherein the thermal spraying is cold-gas spraying.

11. The method as claimed in claim 9, wherein the component is coated in a surface region which is not more than 10% larger than a soldered connection region that is produced between the component and another component.

12. The method as claimed in claim 9, wherein the component is only coated in a surface region where a soldered connection is to be formed.

13. The method as claimed in claim 9, wherein alternating layers of silver and copper are produced on the component by alternately thermal spraying a powder containing silver and a powder containing copper.

14. The method as claimed in claim 9, wherein the coating is performed by thermal spraying a powder mixture containing both silver and copper.

15. The method as claimed in claim 9, wherein
the thermal spraying is cold-gas spraying,
the component is coated in a surface region, and
the method further comprises cleaning the surface region by cold-gas spraying the powder, the surface region being cleaned by powder particles impacting the surface region, the cleaning being performed such that while cleaning, adjusted cold-gas spraying coating parameters are used so as to preclude adherence of the powder particles to the surface region.

16. The method as claimed in claim 15, wherein the surface region is coated after the surface region is cleaned.

17. The method as claimed in claim 9, wherein the component forms an electrical screening part of the vacuum interrupter or a wall part of a housing of the vacuum interrupter.

18. The method as claimed in claim 10, wherein the component is coated in a surface region which is not more than 10% larger than a soldered connection region that is produced between the component and another component.

19. The method as claimed in claim 18, wherein alternating layers of silver and copper are produced on the component by alternately thermal spraying a powder containing silver and a powder containing copper.

20. The method as claimed in claim 18, wherein the coating is performed by thermal spraying a powder mixture containing both silver and copper.

21. The method as claimed in claim 18, wherein
the thermal spraying is cold-gas spraying,
the component is coated in a surface region, and
the method further comprises cleaning the surface region by cold-gas spraying, the surface region being cleaned by powder particles impacting the surface region, the cleaning being performed such that while cleaning, adjusted cold-gas spraying coating parameters are used so as to preclude adherence of the powder particles to the surface region.

22. The method as claimed in claim 21, wherein the surface region is coated after the surface region is cleaned.

23. The method as claimed in claim 22, wherein the component forms an electrical screening part of the vacuum interrupter or a wall part of a housing of the vacuum interrupter.

24. A method for producing a vacuum interrupter, comprising:
coating a surface region of a first component with a solder material, the coating being performed by thermal spraying a powder containing silver; and
soldering the surface region of the first component to a second component.

25. The method as claimed in claim 24, wherein the solder material is applied to the first component without electrochemical deposition of silver.
